(19) United States
(12) Patent Application Publication
(10) Pub. No.: US 2012/0297418 A1
(43) Pub. Date: Nov. 22, 2012

(54) EXTERNAL APPLICATION PROCESSOR FOR MULTIMEDIA DEVICES

(75) Inventor: Helmut Eduard Neumann, Urbandale, IA (US)

(73) Assignee: SONY CORPORATION, Tokyo (JP)

(21) Appl. No.: 13/113,000

(22) Filed: May 20, 2011

(51) Int. Cl. H04N 5/445

(52) U.S. Cl. 725/37

(57) ABSTRACT

An embodiment is a technique to provide enhancement functionality to a multimedia device. A system interface provides interface to a system processor embedded in a device having multimedia capabilities. A communication interface provides connection to a communication network for accessing to an application source. An application processor provides an enhancement functionality to the device utilizing the application source and the multimedia capabilities.

### TECHNICAL FIELD

The presently disclosed embodiments are directed to the field of multimedia, and more specifically, to application processor technologies.

### BACKGROUND

Advances in television (TV) and multimedia have enabled high-end television systems with high reliability and superior quality. A variety of television and multimedia devices such as flat-panel Liquid Crystal Display (LCD) or plasma television sets are available with extended life cycles. However, technologies in communication, networks, mobile devices, hand-held devices, processor architectures, software and applications have advanced at a much faster rate than television and multimedia. The mismatch between the two technological trends leads to unbalanced product improvements over the lifespan of television and multimedia systems. In addition, due to market competition, it is important to lower the costs associated with television and multimedia systems and therefore it is difficult to incorporate into these devices advanced and powerful processors that may accommodate future needs.

Techniques to provide expandable capabilities to multimedia devices and systems have a number of drawbacks. One technique uses field upgrade that upgrades easily modifiable components such as software in the field. This technique has limited scope because it may only support applications or devices that can be field upgraded. Another technique employs Internet connection directly to the multimedia systems to add future capabilities. This technique, however, is not fully separable from the multimedia systems and is also costly.

### SUMMARY

One disclosed feature of the embodiments is a method and apparatus to provide enhancement functionality to a multimedia device. A system interface provides interface to a system processor embedded in a device having multimedia capabilities. A communication interface provides connection to a communication network for accessing to an application source. An application processor provides an enhancement functionality to the device utilizing the application source and the multimedia capabilities.

### BRIEF DESCRIPTION OF THE DRAWINGS

Embodiments may best be understood by referring to the following description and accompanying drawings that are used to illustrate embodiments. In the drawings.

FIG. 1 is a diagram illustrating a system for external application processing according to one embodiment.

FIG. 2 is a diagram illustrating an application processor unit according to one embodiment.

FIG. 3 is a diagram illustrating an application source according to one embodiment.

FIG. 4 is a flowchart illustrating a process for external application processing according to one embodiment.

FIG. 5 is a diagram illustrating a processing system to provide external application according to one embodiment.

### DETAILED DESCRIPTION

One disclosed feature of the embodiments is a technique to provide enhancement functionality to a multimedia device. A system interface provides interface to a system processor embedded in a device having multimedia capabilities. A communication interface provides connection to a communication network for accessing to an application source. An application processor provides an enhancement functionality to the device utilizing the application source and the multimedia capabilities.

In the following description, numerous specific details are set forth. However, it is understood that embodiments may be practiced without these specific details. In other instances, well-known circuits, structures, and techniques have not been shown to avoid obscuring the understanding of this description.

One disclosed feature of the embodiments may be described as a process which is usually depicted as a flowchart, a flow diagram, a structure diagram, or a block diagram. Although a flowchart may describe the operations as a sequential process, many of the operations can be performed in parallel or concurrently. The beginning of a flowchart may be indicated by a START label. The end of a flowchart may be indicated by an END label. In addition, the order of the operations may be re-arranged. A process is terminated when its operations are completed. A process may correspond to a method, a program, a procedure, a method of manufacturing or fabrication, etc. One embodiment may be described by a schematic drawing depicting a physical structure. It is understood that the schematic drawing illustrates the basic concept and may not be scaled or depict the structure in exact proportions.

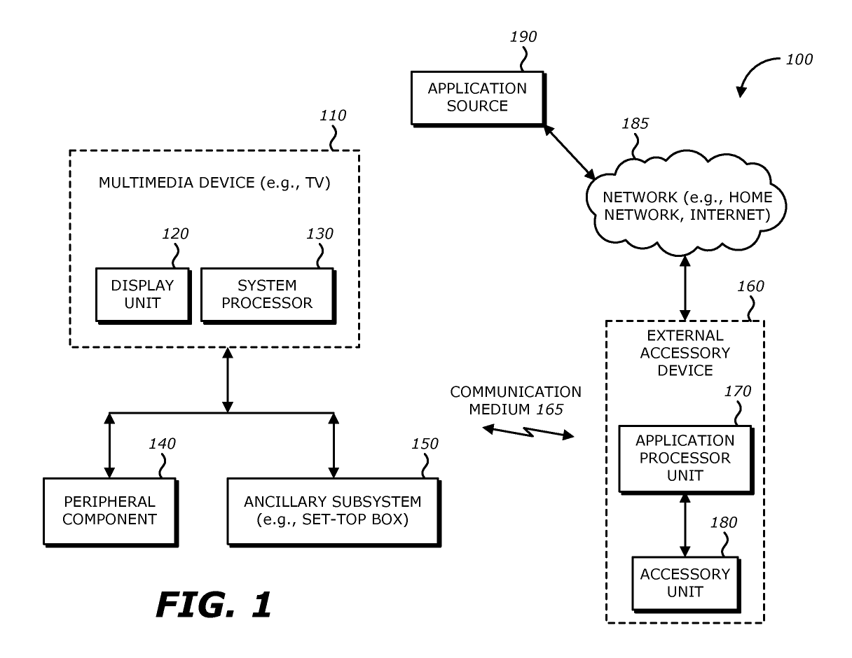

FIG. 1 is a diagram illustrating a system 100 for external application processing according to one embodiment. The system 100 may include a multimedia device 110, an accessory device 160, a network 185, and an application source 190. The system 100 may include more or less than the above components.

The multimedia device 110 may be any device or system that may have multimedia capabilities such as imaging, graphics, video, and audio processing. In general, the multimedia device 110 may be a device that is dedicated to multimedia processing without specialized information technology (IT) functionalities. By detaching the IT functionalities from the device 110, the implementation of the device 110 may be more economical than a device that has these functionalities integrated within itself. In one embodiment, the multimedia device 110 may be a television (TV) set. The TV set may be a consumer or commercial TV unit. It may be a broadcast TV that receives broadcast programs from programming stations. It may receive the programs via satellite transmission, cables, antenna, etc. It may include a display unit 120 and a system processor 130. It may include other devices such as receiver, down converter, analog-to-digital converter, digital-to-analog converter, filters, etc. The display unit 120 may be a cathode ray tube (CRT) or a flat-panel display (FPD). The FPD may be any one of a plasma display, liquid crystal display (LCD), organic light emitting diode display (OLED), light-emitting diode display (LED), electroluminescent display (ELD), surface-conduction electron-emitter display (SED), field emission display (FED), or any other suitable displays. The system processor 130 may be any suitable processor that is embedded in the multimedia device 110. The system processor 130 may be a general purpose processor, a multimedia processor, a digital signal processor, a graphic processor, or any combination of these processors. The system processor 130 typically has communication interface to other devices via wired or wireless connectivity. The system processor 130 may have multimedia capabilities such as imaging and graphics processing and rendering, audio processing, and other signal processing capabilities. The system processor 130 may render imaging and graphics for display on the display unit 120, provides user interface, and other system functionalities to the multimedia device 110.

The multimedia device 110 may have interface to a peripheral component 140 and an ancillary subsystem 150. The peripheral component 140 may be any peripheral component such as a voice box, a storage device, an input/output device, a headphone, a loud speaker, etc. The ancillary subsystem 150 provides ancillary functions to the multimedia device 110. It may be a set-top box, an external audio (e.g., audio player) or video device (e.g., video recorder), a storage subsystem. Any of the multimedia device 110, the peripheral component 140, and the ancillary subsystem 150 may have communication interface to a communication medium 165. The communication medium 165 may be any medium for communication. It may be a wired or wireless communication medium. It may be an electromagnetic, optical, sonic, radio, infrared, or ultrasound medium.

The accessory device 160 is any accessory device that is external to the multimedia device 110 and communicates to the multimedia device via the communication medium 165. It may be a device that performs any accessory function to the multimedia device 110. It may be a remote controller, a game console, an input/output device, an application processing unit, etc. It may have limited display and user interface capabilities. In general, the accessory device 160 may be easily replaced to operate with the multimedia device 110 because it is external to and separate from the multimedia device 110. The accessory device 160 may include an application processor unit 170 and an accessory unit 180.

The application processor unit 170 provides enhancement functionality to the multimedia device 110. In one embodiment, the application processor unit 170 may have more powerful capabilities than the multimedia device 110 in terms of specialized information technology (IT) applications. In general, IT functionalities may be incorporated into the application processor unit 170. Since IT technologies advance at a faster rate than the multimedia technologies, it is more economical and convenient to transfer these functionalities outside of the multimedia device 110 and into the application processor unit 170 so that these functionalities can be upgraded without impacting the economic investment in the multimedia device 110. In one embodiment, the application processor unit 170 may download an application from the application source 190 to provide the enhancement functionalities to the multimedia device 110.

The accessory unit 180 may be optional and may perform accessory function. It may include functionalities such as remote control, limited user interface, input/output functions, etc. It may include an entry device such as a keyboard, a display, an audio device, or an imaging or video device. It may have control functions such as an accelerometer or those found in a game console.

The network 185 may be any suitable communication network. It may be a home network with wired or wireless connectivity. It may use shielded or unshielded twisted pair cabling, such as any of the Category 3 (CAT3) through Category 6 (CAT6) classes. It may use coaxial cables, or existing electrical power wiring within homes. It may use wireless connectivity such as radio connectivity with the Institute of Electrical and Electronics Engineers (IEEE) 802.11 standards (e.g., 802.11a/b/g/n). The network 185 may also be a Local Area Network (LAN) or a Wide Area Network (WAN). It may be the Internet, an intranet, or an extranet.

The application source 190 may be a source of providing applications to the application processor unit 170. The applications provide functionalities that may not be readily available within the multimedia device 110.

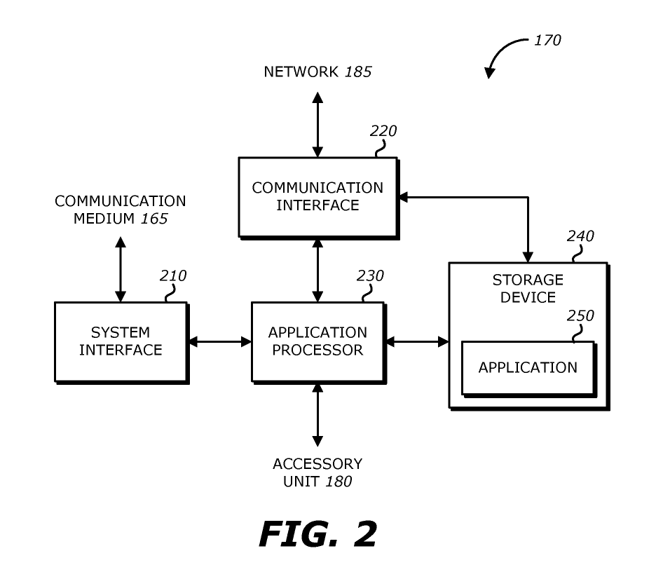

FIG. 2 is a diagram illustrating the application processor unit 170 according to one embodiment. The application processor unit 170 may include a system interface 210, a communication interface 220, an application processor 230, and a storage device 240. The application processor unit 170 may include more or less than the above elements.

The system interface 210 may provide interface to the system processor 130 (shown in FIG. 1) embedded in the multimedia device 110 having multimedia capabilities. The system interface 210 may include the physical structures to provide connection to the communication medium 165. These physical structures may include communication interface devices that are compatible to the communication medium 165 in wired or wireless connectivity. It may include a docking station that allows the application processor unit 170 to dock directly to the multimedia device 110. It may include buffers or temporary storage elements to store data or commands received from or transmitted to the system processor 130. In addition, the system interface 210 may include data paths or protocols that are established to facilitate the exchange of information or data between the system processor 130 and the application processor 230. For example, the system processor 130 may receive data from the application processor 230 to render graphics for display on the display unit 120.

The system interface 210 may also provide interface to the peripheral component 140 and/or the ancillary subsystem 150 to allow communication with the application processor 230 with these components. For example, if the ancillary subsystem 210 is a video recorder, the application processor 230 may send commands to the ancillary subsystem 210 to record a video clip as part of the application streaming data to the multimedia device 110.

The communication interface 220 may provide connection to the communication network 185 for accessing to the application source 190. The communication interface 220 may include devices that perform communication functions such as a network interface device. In addition, the communication interface 220 may include buffers or temporary data storage elements to store temporary data. It may also include data structures or circuitry to facilitate the establishment of a communication protocol with the network 185.

The application processor 230 is coupled to the system and communication interfaces 210 and 220 to provide an enhancement functionality to the device 110 utilizing the application source 190 and the multimedia capabilities in the device 110. The application processor 230 may be a central processing unit of any type of architecture, such as processors using hyper threading, security, network, digital media technologies, single-core processors, multi-core processors, embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The storage device 240 is coupled to the application processor 230 to store an application 250 that provides the enhancement functionality. The application 250 may be downloaded remotely via the communication network 185 from the application source 190. The application 250 may be any one of a user interface application, an imaging application, a graphic rendering application, a social network application, a communication application (e.g., text message, mobile phone, voice, audio, video), a mail application, an entertainment application (e.g., game, music), a sports application, a news application, a search application, or a financial application (e.g., stock quotes, financial planning). The application processor 230 may run the application 250 and deliver the results to the multimedia device 110. Since the application 250 represents technologies and applications that are detached from the multimedia device 110, the application processor 230 may provide enhancement functionalities according to present and future technologies without tying to the specific structure of the device 110.

The storage device 240 may be implemented with dynamic random access memory (DRAM), static random access memory (SRAM), or any other types of memories including those that do not need to be refreshed, including read only memory (ROM), flash memories. The storage device 240 may also include a mass storage medium such as compact disk (CD) read-only memory (ROM), memory stick, memory card, smart card, digital video/versatile disc (DVD), floppy drive, hard drive, tape drive, and any other electronic, magnetic or optic storage devices. The mass storage device provides a mechanism to read machine-accessible media. The storage device 240 may include both volatile memory and non-volatile memory.

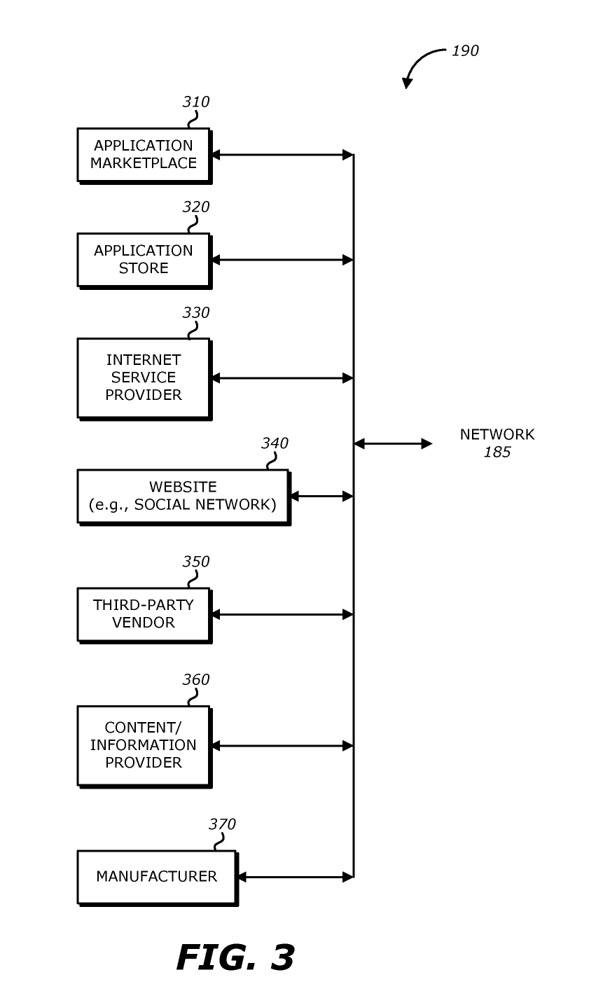

FIG. 3 is a diagram illustrating the application source 190 according to one embodiment. The application source 190 may be any one or more of an application marketplace 310, an application store 320, an Internet service provider (ISP) 330, a Website 340, a third-party vendor 350, a content or information provider 360, or a manufacturer 370.

The application marketplace 310 may be any user-driven content distribution system such as the Google Android market. It may provide a market where developers make their content available in an open and unobstructed environment. The application store 320 may be any on-line application store that provides applications for users such as the Apple Apps store. The applications may be an entertainment application (e.g., music, movies, audio, video), a game application, a mobile application, a mail application, etc. The ISP 330 may be any ISP that provides on-line applications such as Google, Yahoo, etc. The applications may include a search application, a news application, a financial application, etc. The Website 340 may be any Website that provides on-line services such as social networking (e.g., MySpace, Facebook, Twitter, LinkedIn), media (e.g., YouTube), The Website 340 may provide a suitable plug-in to allow the application processor 220 to establish connection to the Website. The third-party vendor 350 may provide applications that are suitable for access to be used with the multimedia device 110. The content or information provider 360 may be any content provider that provides information or content to others. The manufacturer 370 may provide applications that are geared toward the multimedia device 110. It may be the manufacturer of the multimedia device 110. The application from the manufacturer 370 may be a software update, an error fixing application, a utility application, etc.

The application source 190 may represent constantly updated applications or new applications that are developed according to current or future technologies. Accordingly, these applications provide enhancement functionalities to the multimedia device 110 through the application processor unit 170.

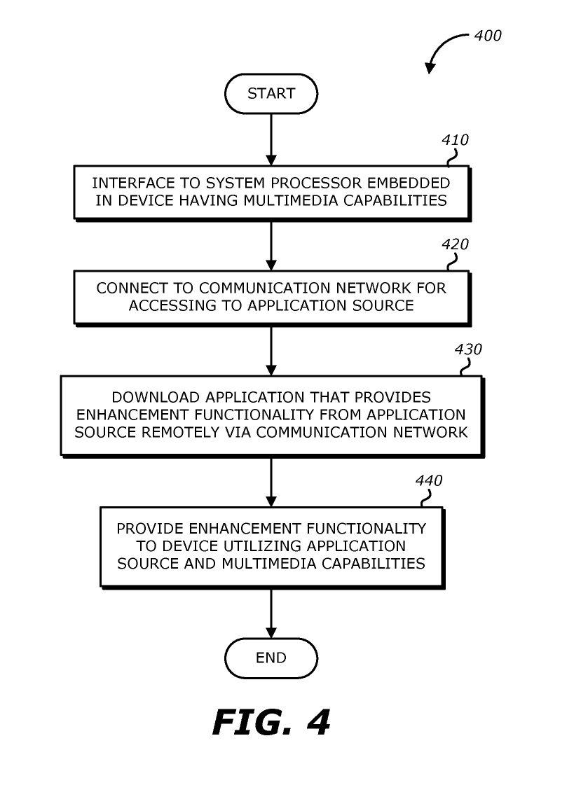

FIG. 4 is a flowchart illustrating a process 400 for external application processing according to one embodiment.

Upon START, the process 400 interfaces to a system processor embedded in a device having multimedia capabilities (Block 410). In one embodiment, the device is a television unit. Next, the process 400 connects to a communication network for accessing to an application source (Block 420). The application source may be any one of an application marketplace, an application store, an Internet service provider, a Website, a third-party vendor, and a manufacturer. Then, the process 400 downloads an application that provides an enhancement functionality from an application source remotely via the communication network (Block 430). The application may be any one of a user interface application, an imaging application, a graphic rendering application, a social network application, a communication application, a mail application, an entertainment application, a sports application, a news application, a search application, and a financial application. Next, the process 400 provides the enhancement functionality to the device utilizing the application source and the multimedia capabilities (Block 440). The process 400 is then terminated.

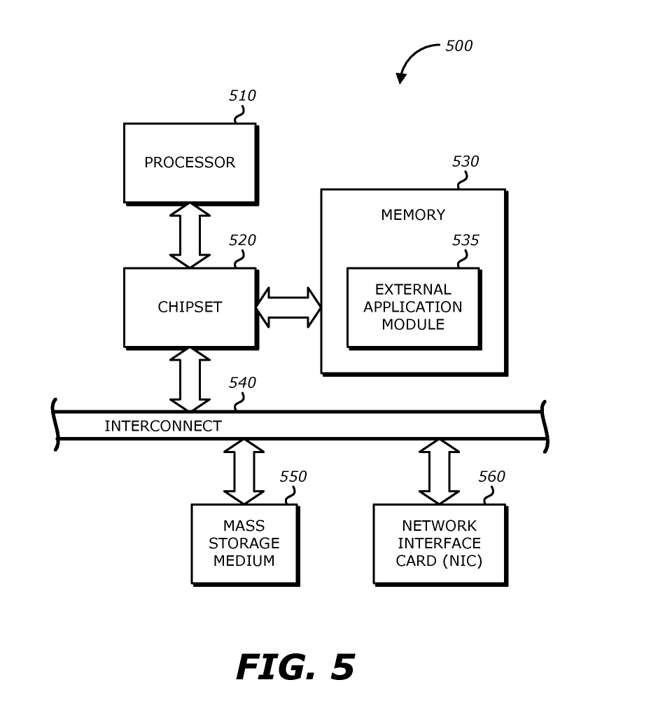

FIG. 5 is a diagram illustrating a processing system 500 to provide external application according to one embodiment. The processing system 500 may be a part of a computer system, an accessory device, or a mobile device. It may correspond to the application processor unit 170 or the application processor 230. It may include a processor 510, a chipset 520, a memory 530, an interconnect 540, a mass storage medium 550, a network interface card 560. The processing system 500 may include more or less than the above components.

The processor 510 may be a central processing unit of any type of architecture, such as processors using hyper threading, security, network, digital media technologies, single-core processors, multi-core processors, embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The chipset 520 provides control and configuration of memory and input/output (I/O) devices such as the memory 530, the mass storage medium 550, and the network interface card 560. The chipset 520 may integrate multiple functionalities such as I/O controls, graphics, media, host-to-peripheral bus interface, memory control, power management, etc.

The memory 530 stores system code and data. The memory 530 is typically implemented with dynamic random access memory (DRAM), static random access memory (SRAM), or any other types of memories including those that do not need to be refreshed, including read only memory (ROM), flash memories. In one embodiment, the memory 530 may contain an external application module 535. It is contemplated that the external application module 535, or any of its components, may be implemented by hardware, software, firmware, or any combination thereof.

The interconnect 540 provides an interface for the chipset 520 to communicate with peripheral devices such as the mass storage medium 550 and the NIC 560. The interconnect 540 may be point-to-point or connected to multiple devices. For clarity, not all the interconnects are shown. It is contemplated that the interconnect 540 may include any interconnect or bus such as Peripheral Component Interconnect (PCI), PCI Express, Universal Serial Bus (USB), and Direct Media Interface (DMI), etc. The mass storage medium 550 may include compact disk (CD) read-only memory (ROM), memory stick, memory card, smart card, digital video/versatile disc (DVD), floppy drive, hard drive, tape drive, and any other electronic, magnetic or optic storage devices. The mass storage device provides a mechanism to read machine-accessible media. The NIC 560 provides interface to a network such as the Internet or a local area network.

Elements of one embodiment may be implemented by hardware, firmware, software or any combination thereof. The term hardware generally refers to an element having a physical structure such as electronic, electromagnetic, optical, electro-optical, mechanical, electro-mechanical parts, etc. A hardware implementation may include analog or digital circuits, devices, processors, applications specific integrated circuits (ASICs), programmable logic devices (PLDs), field programmable gate arrays (FPGAs), or any electronic devices. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc., that is implemented or embodied in a hardware structure (e.g., flash memory). Examples of firmware may include microcode, writable control store, micro-programmed structure. When implemented in software or firmware, the elements of an embodiment may be the code segments to perform the necessary tasks. The software/firmware may include the actual code to carry out the operations described in one embodiment, or code that emulates or simulates the operations. The program or code segments may be stored in a processor or machine accessible medium. The “processor readable or accessible medium” or “machine readable or accessible medium” may include any medium that may store or transfer information. Examples of the processor readable or machine accessible medium that may store include a storage medium, an electronic circuit, a semiconductor memory device, a read only memory (ROM), a flash memory, an erasable programmable ROM (EPROM), a floppy diskette, a compact disk (CD) ROM, an optical storage medium, a magnetic storage medium, a memory stick, a memory card, a hard disk, etc. The machine accessible medium may be embodied in an article of manufacture. The machine accessible medium may include information or data that, when accessed by a machine, cause the machine to perform the operations or actions described above. The machine accessible medium may also include program code, instruction or instructions embedded therein. The program code may include machine readable code, instruction or instructions to perform the operations or actions described above. The term “information” or “data” here refers to any type of information that is encoded for machine-readable purposes. Therefore, it may include program, code, data, file, etc.

All or part of an embodiment may be implemented by various means depending on applications according to particular features, functions. These means may include hardware, software, or firmware, or any combination thereof. A hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

It is anticipated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. An apparatus comprising:
a system interface to provide interface to a system processor embedded in a device having multimedia capabilities;
a communication interface to provide connection to a communication network for accessing to an application source; and
an application processor coupled to the system and communication interfaces to provide an enhancement functionality to the device utilizing the application source and the multimedia capabilities.

2. The apparatus of claim 1 further comprising:
a storage device coupled to the application processor to store an application that provides the enhancement functionality, the application being downloaded remotely via the communication network from the application source.

3. The apparatus of claim 1 wherein the device is one of a television set, a peripheral component accessory to a television system, or a subsystem ancillary to a television set.

4. The apparatus of claim 2 wherein the application is one of a user interface application, an imaging application, a graphic rendering application, a social network application, a communication application, a mail application, an entertainment application, a sports application, a news application, a search application, or a financial application.

5. The apparatus of claim 1 wherein the system interface is a wired or wireless interface.

6. The apparatus of claim 1 wherein the communication interface is a wired or wireless interface.

7. The apparatus of claim 1 wherein the communication network is one of a home network or an Internet network.

8. The apparatus of claim 2 wherein the application source is one of an application marketplace, an application store, an Internet service provider, a content or information provider, a Website, a third-party vendor, or a manufacturer.

9. A method comprising:
interfacing to a system processor embedded in a device having multimedia capabilities;
connecting to a communication network for accessing to an application source; and
providing an enhancement functionality to the device utilizing the application source and the multimedia capabilities.

10. The method of claim 9 further comprising:
downloading an application that provides the enhancement functionality from the application source remotely via the communication network.

11. The method of claim 9 wherein the device is one of a television set, a peripheral component accessory to a television system, or a subsystem ancillary to a television set.

12. The method of claim 10 wherein the application is one of a user interface application, an imaging application, a graphic rendering application, a social network application, a communication application, a mail application, an entertainment application, a sports application, a news application, a search application, or a financial application.

13. The method of claim 9 wherein the system interface is a wired or wireless interface.

14. The method of claim 9 wherein the communication interface is a wired or wireless interface.

15. The method of claim 9 wherein the communication network is one of a home network or an Internet network.

16. The method of claim 10 wherein the application source is one of an application marketplace, an application store, an Internet service provider, a content or information provider, a Website, a third-party vendor, or a manufacturer.

17. A system comprising:
a multimedia device having multimedia capabilities and a system processor embedded therein; and
an accessory device coupled to the multimedia device, the accessory device having an application processor unit, the application processor unit comprising:
a system interface to provide interface to the system processor,
a communication interface to provide connection to a communication network for accessing to an application source, and
an application processor coupled to the system and communication interfaces to provide an enhancement functionality to the multimedia device utilizing the application source and the multimedia capabilities.

18. The system of claim 17 wherein the accessory device further comprises:
a storage device coupled to the application processor to store an application that provides the enhancement functionality, the application being downloaded remotely via the communication network.

19. The system of claim 17 wherein the multimedia device is one of a television set, a peripheral component accessory to a television system, or a subsystem ancillary to a television set.

20. The system of claim 18 wherein the application is one of a user interface application, an imaging application, a graphic rendering application, a social network application, a communication application, a mail application, an entertainment application, a sports application, a news application, a search application, or a financial application.

21. The system of claim 17 wherein the system interface is a wired or wireless interface.

22. The system of claim 17 wherein the communication interface is a wired or wireless interface.

23. The system of claim 17 wherein the communication network is one of a home network or an Internet network.

24. The system of claim 18 wherein the application source is one of an application marketplace, an application store, an Internet service provider, a content or information provider, a Website, a third-party vendor, or a manufacturer.
